(19) United States
(12) Patent Application Publication
(10) Pub. No.: US 2026/0103858 A1
(43) Pub. Date: Apr. 16, 2026

(54) MEASURING DEVICE AND METHOD FOR CONTINUOUSLY FEELING A HEIGHT REFERENCE

(71) Applicant: JOSEPH VÖGELE AG, Ludwigshafen/Rhein (DE)

(72) Inventors: Benjamin BUTZ, Karlsruhe (DE); Jerome PETERSEN, Mannheim (DE); Dirk BERNATZ, Mutterstadt (DE); Frank GRIMM, Edingen-Neckarhausen (DE)

(73) Assignee: JOSEPH VÖGELE AG, Ludwigshafen/Rhein (DE)

(21) Appl. No.: 19/358,935

(22) Filed: Oct. 15, 2025

(30) Foreign Application Priority Data
Oct. 15, 2024 (EP) 24206579.5

(51) Int. Cl. E01C 23/01; G01B 5/06; E01C 19/00

(52) U.S. Cl. CPC E01C 23/01; G01B 5/061; E01C 19/008

(57) ABSTRACT

A measuring device for a paving machine comprises a height sensor and a pivot module mounted to be pivotable on the height sensor about a pivot axis and having a feeling device with at least two feeler levers for feeling a cable stretched along a paving section of the paving machine as a height reference. The at least two feeler levers are configured such that one of the at least two feeler levers is in a first orientation, in which it is positioned resting on the cable, at least always when the another of the at least two feeler levers is pressed, by way of a support that is used to tension the cable, to a second orientation in which it is spaced from the cable.

### CROSS-REFERENCE TO RELATED APPLICATIONS

This application claims foreign priority benefits under 35 U.S.C. § 119(a)-(d) to European patent application number 24206579.5, filed Oct. 15, 2024, which is incorporated by reference in its entirety.

### TECHNICAL FIELD

The present disclosure relates to a measuring device for a paving machine. Furthermore, the present disclosure relates to a method for continuously feeling a height reference.

### BACKGROUND

It is known that a mechanical height sensor attached to the screed of a paving machine can be used to mechanically feel a cable stretched along the paving section of the paving machine or to feel a guide wire in order to detect by way of feeling in a contacting manner any unevenness in the road bed over which the paving machine is moving and, based on this, to level the height-adjustable screed such that a level pavement layer can be produced.

A problem with conventional mechanical height sensors is that they can get caught on tensioning blocks, i.e., on supports mounted along the paving section for tensioning the cable or guide wire. For this reason, conventional height sensors are currently either deactivated in the region of the respective clamping blocks or the clamping blocks are pushed aside by an operator walking alongside the paving machine to prevent the height sensors from getting caught on them. However, temporarily deactivating the height sensors can lead to paving errors because the leveling system does not react to unevenness in the road bed during the deactivation interval. Pushing the support away is labor-intensive for the operator and results in the cable becoming slack along the paving section, requiring the operator to retighten it several times. Without taking such problematic measures, however, it can happen that the leveling of the screed can react if the mechanical height sensor is pushed away or raised from its normal guide at the supports, which can lead to undesirable profile errors in the pavement layer.

DE 21 2024 000 014 U1 discloses a mechanical height sensor for feeling a reference in the form of a cable or guide wire stretched along the paving section of the paving machine. The height sensor comprises a feeler lever in the form of a rotation star which can rotate away when striking a support during the paving run and is thereby raised from the cable and above the support. When the rotation star is rotated away from a support, an upper sensor member of the height sensor forming the rotation star moves upwardly over an ascending inclined guide of a lower sensor member so that the rotation star striking the support is spaced from the cable and raised above the support, where the rotation star lowers as it rotates further on the support along a descending inclined guide of the lower sensor member and is again made to contact the cable. Although this allows the rotation star to bypass the supports positioned along the paving section without manual intervention, this measuring device has the disadvantage that none of the sensors attached to the rotation star rest on the cable at the respective supports, at least temporarily, meaning that the measuring process for mechanically scanning the height reference at the respective supports is interrupted. Unevenness in the road bed, particularly in the region of the supports, on which the paving machine is moving, is therefore not taken into account in the measurement for leveling the screed or is only recorded inaccurately, so that the leveling may be inaccurate.

### SUMMARY

An object of the present disclosure is to provide a measuring device and a corresponding method that are improved with regard to the disadvantages described in the context of prior art.

This object is satisfied by a measuring device according to the disclosure as well as a method according to the disclosure.

Advantageous further developments according to the disclosure are also provided.

The disclosure relates to a measuring device for a paving machine, comprising a height sensor and a pivot module which is mounted on the height sensor to be pivotable about a pivot axis and which comprises a feeling device with at least two feeler levers for feeling a cable tensioned as a height reference along a paving section of the paving machine. The disclosure provides that the two feeler levers are configured such that one of the two feeler levers is in a first orientation, in which it is positioned resting on the cable, at least always when the other of the two feeler levers is pressed, by way of a support that is used to tension the cable, into a second orientation, in which it is spaced from the cable.

Therefore, at least one of the two feeler levers is always in contact with the cable, even if one of the two feeler levers strikes a support and is thereby detached from cable contact. Consequently, the measuring device according to the disclosure makes it possible to maintain feeling the cable continuously on a contact basis even when the cable passes a support. In other words, the measuring device according to the disclosure maintains contact with the cable without losing contact at a support. Even in the region of the support, this ensures uninterrupted feeling of the cable, i.e., continuous guidance of the feeling device along the cable so that measurement values are recorded without interruption and, consequently, the screed provided at the paving machine can level more precisely during a paving run.

During a paving run of the paving machine, if one of the two feeler levers touches a support, e.g., a tensioning block for tensioning the cable or for tensioning a guide wire used instead of the cable, this feeler lever can yield to the support due to the contact, i.e., be pushed away from the support, thereby spacing it from the cable, while the other of the two feeler levers either remains resting on the cable or is moved onto it before the feeler lever that is pushed away from the support temporarily breaks its contact with the cable. The feeling device according to the disclosure is therefore always in contact with the cable with at least one of the two feeler levers so that more precise leveling is made possible.

The feeler levers are preferably separate feeler levers that are mounted to be rotatable about separate axes of rotation spaced from one another, in particular vertical axes of rotation. Such a two-part design of the two feeler levers allows one of the two feeler levers to yield at a support and thus be spaced from the cable, while the other feeler lever notwithstanding this remains positioned resting on the cable at a different location along the cable, thereby ensuring continuous cable feeling contact. The two separate feeler levers therefore complement each other perfectly to enable continuous cable feeling contact along the paving section.

According to one embodiment of the disclosure, the distance between the two axes of rotation can be varied. The feeler levers can then be mounted apart at different distances. This makes it possible to mount the feeler levers, in terms of the selected distance that the supports are at along the paving stretch, such that they do not pass the supports at the same time. This allows the feeler levers to be mounted far enough apart, for example, at a distance of 30 cm, 40 cm, or 50 cm from each other, that they do not lose contact with the cable at the same time during use.

Preferably, the feeler levers are mounted such that they are pivotable in a horizontal plane. To ensure that they are positioned in a preferred orientation relative to and on the cable, the feeler levers can be adjusted, preferably in steps, within a predetermined pivot range. This can be done in such a way that the feeler levers can tend to assume a transverse position on the cable or automatically return to a position once they have passed a support.

One variant provides for at least one of the feeler levers to be present in the form of a single lever or in the form a multiple lever. In the form of a single lever, the feeler levers are configured as compact rods and can be mounted individually and spaced from one another at the side of the paving machine, in particular both at the height and/or to the side of a transverse-distributing auger mounted forward of the paving machine's screed, such that they rest on the cable in a manner facing sideways transverse to the paving direction. In the form of a multiple lever, the feeler levers could be configured as respective individual rotation stars. For leveling purposes, the rotation stars could be mounted spaced from one another at the side of the paving machine, in particular both at the height and/or to the side of a transverse-distributing auger mounted forward of the paving machine's screed. A feeling device with feeler levers configured as rotation stars provides a particularly stable structure.

It would be conceivable for the respective feeler levers configured as rotation stars to be configured such that, when a feeler lever on one of the two rotation stars comes into contact with a cable support, this feeler lever can be rotated about its axis of rotation such that it only leaves the cable when another feeler lever adjacent on the rotation star has already reached the cable, thus enabling a seamless feeler lever change at the respective rotation star. Since this allows two feeler levers to rest on the cable at any time, the rotation stars can interact to prevent the feeling device from tilting.

One variant provides for the feeler levers, in particular when present as single feeler levers, to be pretensioned to the first orientation under spring load. This allows the feeler levers to automatically pivot back to their first orientation after passing a support in order to again rest on the cable.

It would be conceivable for the feeler levers to be in the form of a double lever mounted to be rotatable about a single axis of rotation. The measuring device can also comprise several of them. Such a double lever works in such a way that, as soon as one of the two feeler levers formed thereon strikes against a support, this feeler lever rotates about the common axis of rotation such that it moves away from the cable only when the other feeler lever has already been rotated far enough to be disposed on the cable. With such a double lever, a swap of the feeler levers formed thereon takes place on the cable such that a single one of them rests on the cable without being pivoted out along the cable, and by pivoting out this feeler lever, also the other one, i.e., both feeler levers, rest on the cable at least temporarily. Once the feeler lever pushed away by the support has passed the support, i.e., is no longer pushed away by it, it can be rotated back to the first orientation by a spring load so that the other feeler lever again lifts off the cable. The other feeler lever resting on the cable then pivots away from the cable such that it moves away from the cable only when the feeler lever previously pushed away has already been rotated back far enough to rest on the cable again. Even when pivoting back like this about the axis of rotation, the two feeler levers remain at least temporarily resting together on the cable both when pivoting outwardly and inwardly in opposite directions so that a change of position between the two feeler levers on the cable is seamless, meaning that at least one of the two feeler levers is always resting on the cable.

It would be useful if, with a double lever, one of the feeler levers were mounted in the first orientation and the other feeler lever in the second orientation pretensioned under spring load when feeling the cable. From this spring mounting, the two feeler levers on the cable can be reliably changed such that they are at least temporarily positioned resting on the cable at the same time when passing a support, i.e., by pushing away one of the two feeler levers at a support, the other feeler lever is thereby rotated onto the cable and has arrived on the cable before the feeler lever pushed away is spaced from the cable.

It would be advantageous if the feeler levers were aligned at an angle greater than 80° and less than 100° to each other, preferably aligned at right angles to each other. In this arrangement, the two feeler levers on a double feeler lever can be used for continuous cable feeling, since, when passing a support, they are positioned relative to each other such that they rest on the cable at least temporarily at the same time, thereby ensuring continuous cable feeling contact. The feeler levers are preferably formed to be at least 10 cm long, more preferably at least 20 cm long.

The feeling device preferably comprises at least two feeler levers spaced from one another which are in the first orientation when feeling the cable while another, third feeler lever is in the second orientation. This prevents the feeling device from tilting, since the two feeler levers resting on the cable provide sufficient support for the feeling device to maintain the feeling device in a predetermined pivoting position, in particular horizontally aligned on the cable.

According to one embodiment of the disclosure, the pivot module forms a parallelogram hinge for carrying the feeling device. The parallelogram hinge ensures a robust construction of the pivot module so that it can hold the feeling device in a desired horizontal pivot position.

In particular, the parallelogram hinge comprises a mounting rail for the feeler levers. The mounting rail provides a stable base for attaching the feeler levers, allowing them to selectively evade the supports. The mounting rail can be horizontally aligned at the parallelogram hinge to position the feeler levers mounted thereon in a horizontal plane.

It would be conceivable for the feeler levers to be mounted to be adjustable along the mounting rail in order to adjust a distance between the feeler levers, i.e., between their axes of rotation. This allows the contact points of the feeler levers on the cable to be spaced at different distances to accommodate different support spacings. This prevents the feeler levers from simultaneously passing supports. For this purpose, it could be provided that the mounting rail is extendable.

It would be conceivable for the parallelogram hinge to have a counterweight unit for the feeling device. Using the counterweight unit, the pivot module can be positioned in a desired pivot position to guide the feeling device resting on the cable at a predetermined height above the road bed. In particular, the sensitivity of the measuring device can be adjusted using the counterweight unit. Preferably, a force exerted by the counterweight unit is variable. The counterweight unit can comprise plate segments that can be attached and removed for this purpose.

One variant provides for the feeler levers to form an upwardly rising bevel at their outer ends. This helps to reliably guide the feeler levers back onto the cable.

According to one embodiment of the disclosure, it is provided that the feeling device comprises at least one stopper element for holding the feeler levers in a predetermined orientation of the feeler levers relative to the cable, in particular in an orthogonally traversing orientation relative to the cable. This makes it possible to guide the feeler levers substantially perpendicular to the alignment of the cable during cable feeling, ensuring they glide reliably over the cable and preventing the feeler levers from striking against a clamping block head-on.

It would be conceivable for the stopper element to define a latching position, for example, on a feeler lever which is present in the form of a rotation star, or is present as an end stop, for example, on a single or double lever to stop the feeler levers when pivoting back transverse to the alignment of the cable.

In particular, the feeler levers can be used for cable feeling both to the right as well as to the left beside the paving machine. It would be conceivable for the multiple levers arranged in the form of a rotation star to be configured such that a cable can be felt in the direction of travel both to the right and to the left of the paving machine. Alternatively, a corresponding left or right version of the rotation star could be provided for the feeling performed on the right and left sides of the machine.

It would be advantageous to have the single or double levers be configured such that they could be pivoted or converted from feeling in the direction of travel to the right of the paving machine to feeling in the direction of travel to the left of the paving machine. Alternatively, versions for use on the left side of the paving machine or the right side of the paving machine are provided.

The disclosure further relates to a paving machine with at least one mechanical measuring device according to the disclosure. Such a measuring device enables a continuous contact-based height measurement to be performed during a paving run of the paving machine against a reference stretched along the paving section, e.g., a cable or a guide wire, in order to enable, based thereupon, the precise leveling of the screed of the paving machine. Such contact-based feeling of the height reference provides the advantage of weather-independent and robust operation, in particular compared to contactless measuring systems, such as ultrasonic sensors.

The disclosure further relates to a method for continuously feeling a cable stretched along a paving section of a paving machine as a height reference using a measuring device on which a feeling device with at least two feeler levers for feeling the cable is employed. The method according to the disclosure provides that one of the two feeler levers is always in a first orientation in which it rests on the cable when the other of the two feeler levers is pushed away from the cable by a support that tensions the cable to a second orientation in which it is spaced from the cable. This ensures that at least one of the two feeler levers is always in contact with the cable, even when the feeler levers have to pass cable supports. This enables continuous feeling of the cable by the feeling device so that height measurements are continuously available for leveling the screed of the paving machine, in order to precisely level the screed to produce a level pavement layer.

### BRIEF DESCRIPTION OF THE DRAWINGS

The disclosure shall be explained in more detail using embodiments shown in the figures, where:

FIG. 1 shows a side view of a paving machine with a measuring device for feeling a guide wire or cable, respectively;

FIG. 2 shows a rear view of a paving machine with a measuring device for feeling a guide wire or cable, respectively;

FIG. 3 shows a measuring device for feeling a guide wire or cable, respectively, in an isolated view;

FIGS. 4A-4C show continuous feeling of the guide wire or cable, respectively, using the measuring device shown in FIG. 3;

FIGS. 5A-5D show continuous feeling of the guide wire or cable, respectively, using an alrernative measuring device; and

FIG. 6 shows a measuring device according to a further embodiment.

### DETAILED DESCRIPTION

Technical features are provided with the same reference numerals throughout the figures.

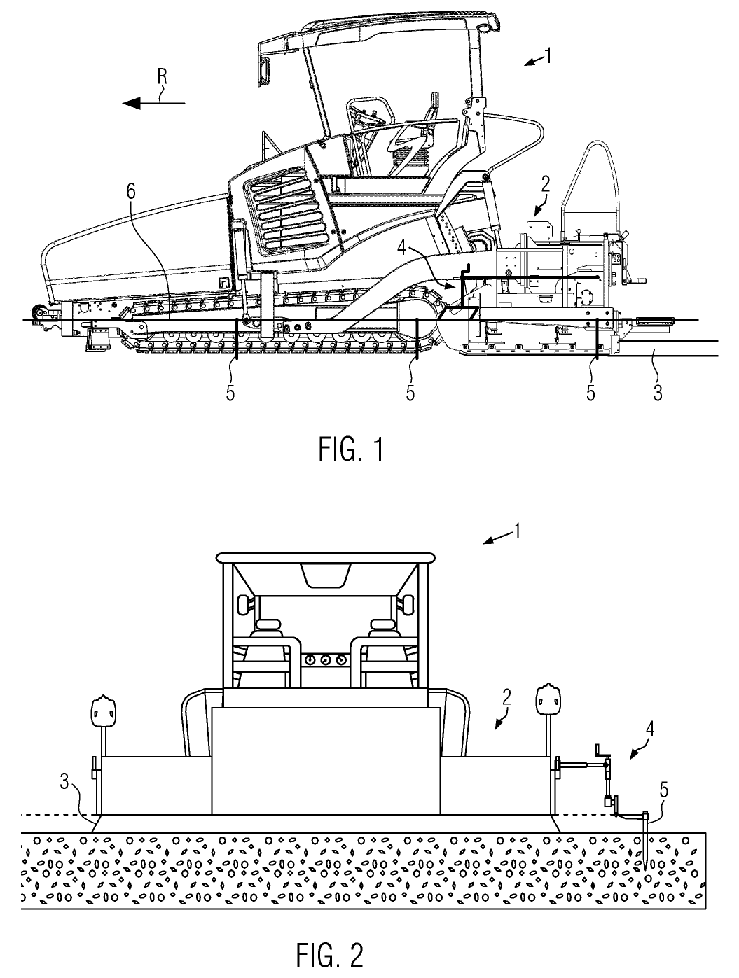

FIG. 1 shows a side view of a paving machine 1 during a paving run in paving direction R. Paving machine 1 comprises a screed 2 adjustable in height for producing a new pavement layer 3 in paving direction R. A measuring device 4 is attached to screed 2. This measuring device is located at the side of a transverse distribution auger that is positioned forward of screed 2 and used for transverse distribution. Measuring device 4 is used for feeling a cable 6 or guide wire, respectively, stretched by way of supports 5 along the paving section in paving direction R.

During the paving run of paving machine 1, the measured values recorded by measuring device 4 are stored as actual values for an automatic leveling system provided on paving machine 1, based on which the height position of screed 2 can be controlled in an open-loop or closed-loop manner by way of leveling cylinders attached to the front traction points of screed 2 in order to produce an even pavement layer 3 by leveling the screed. For precise leveling of screed 2, it is advantageous to have cable 6 be continuously felt using measuring device 4, even when measuring device 4 is guided past respective supports 5.

FIG. 2 shows a rear view of paving machine 1. FIG. 2 shows that the felt cable 6 is located outside the paving region, i.e., to the side of screed 2.

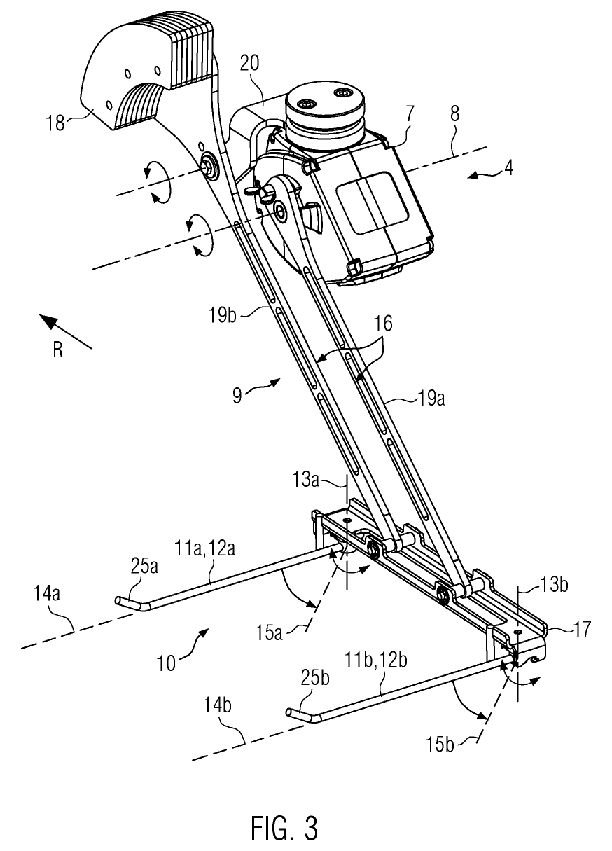

FIG. 3 shows a variant of measuring device 4 in an isolated view. Measuring device 4 comprises a height sensor 7. A pivot module 9 is mounted to be pivotable on height sensor 7 about a pivot axis 8. To detect the pivot position of pivot module 9, a rotary position sensor (not shown) is incorporated in height sensor 7, the measurement signals of which can be stored as actual values for the automatic leveling system in order equalize unevenness sensed by measuring device 4 in the road bed on which paving machine 1 is moving.

Provided at the lower end of pivot module 9 is a feeling device 10 with two feeler levers 11a, 11b. In FIG. 3, feeler levers 11a, 11b are configured in the form of single levers 12a, 12b, each of which is mounted to be rotatable about a vertical axis of rotation 13a, 13b.

In FIG. 3, two feeler levers 11a, 11b are each mounted preloaded in a first orientation 14a, 14b under spring load. According to the dashed illustration in FIG. 3, two feeler levers 11a, 11b can each be rotated from first orientation 14a, 14b to a second orientation 15a, 15b about respective axes of rotation 13a, 13b when they encounter supports 5 that are used to tension cable 6. Once feeler levers 11a, 11b have passed a support 5, they can again pivot from pivoted second orientation 15a, 15b back to first orientation 14a, 14b due to the spring load.

Pivot module 9 shown in FIG. 3 forms a parallelogram hinge 16. Feeling device 10 is mounted at the former´s lower end. Parallelogram hinge 16 comprises a mounting rail 17 on which two feeler levers 11a, 11b are mounted spaced from each other. Furthermore, pivot module 9 comprises a counterweight unit 18 which is arranged on parallelogram hinge 16 on a side facing away from mounting rail 17. Parallelogram hinge 16 comprises a first leg 19a, one end of which is mounted to be pivotable on height sensor 7 about pivot axis 8 and is connected to the rotary position sensor (not shown). Furthermore, parallelogram hinge 16 comprises a second leg 19b which is attached to be rotatable to a support 20 mounted on height sensor 7. Counterweight unit 18 is provided on second leg 19b. Mounting rail 17 is articulated to the lower ends of two legs 19a, 19b.

Measuring device 4 shown in FIG. 3 can be supplemented by a third feeler lever that is mounted to be rotatable on mounting rail 17 between feeler levers 11a, 11b. In particular, measuring device 4 is extendable along mounting rail 17. This means that one or more extension rails can be attached to mounting rail 17 in order to attach one or further feeler levers 11a, 11b thereto, where necessary. It would be conceivable for mounting rail 17 to already be equipped with a telescopic extension rail for attaching at least one additional feeler lever 11a, 11b. This would make it possible to provide feeling device 10 with as many feeler levers 11a, 11b as necessary, for example, three separate feeler levers 11a, 11b so that at least two feeler levers 11a, 11b spaced from one another are positioned in first orientation 14a, 14b resting on cable 6 when feeling cable 6, while the third feeler lever pivots outwardly at a support 5 to avoid the latter. This prevents measuring device 4 from tilting.

Feeler levers 11a, 11b shown in FIG. 3 each have an upwardly facing bevel 25a, 25b. These bevels 25a, 25b assist feeler levers 11a, 11b in pivoting back onto cable 6 and prevent feeler levers 11a, 11b from pivoting back below cable 6.

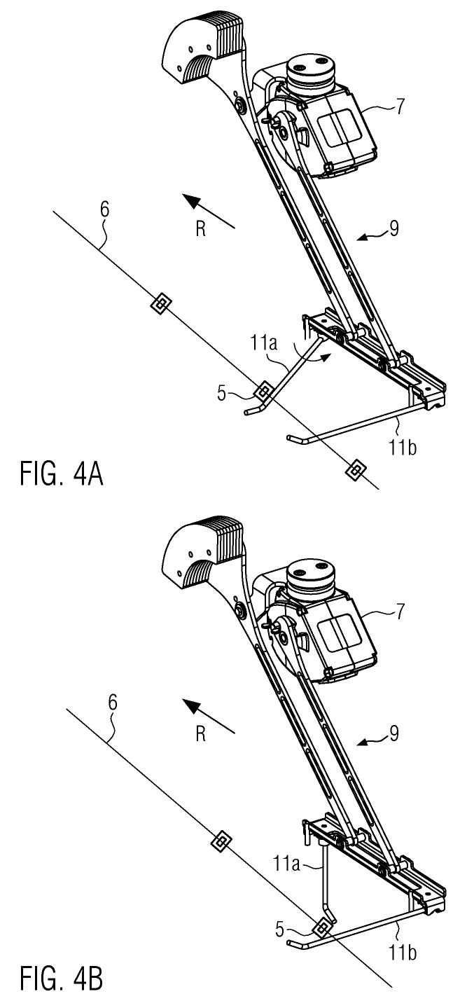

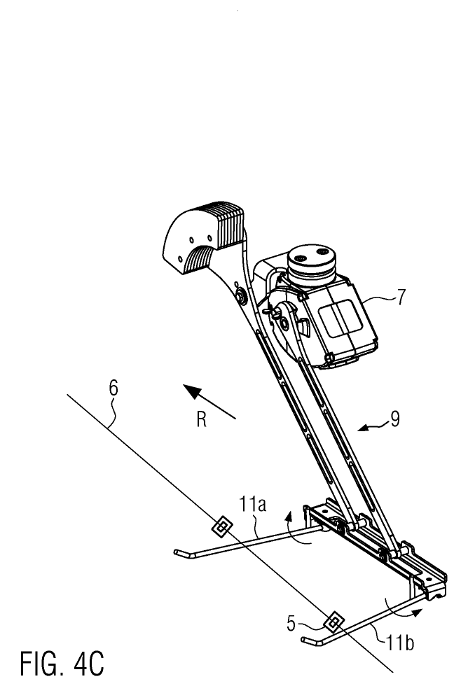

FIG. 4A shows measuring device 4 continuously feeling cable 6. As measuring device 4 moves forward in paving direction R, feeler lever 11a shown in FIG. 4A is pivoted out at a support 5 from its first orientation 14a about axis of rotation 13a. Other feeler lever 11b is positioned in first orientation 14b in FIG. 4A. In FIG. 4A, both feeler levers 11a, 11b are still resting on cable 6.

As paving machine 1 continues to move, measuring device 4 is likewise moved onward in paving direction R, whereby feeler lever 11a is pushed still further away by support 5. This causes feeler lever 11a to pivot so far that it leaves cable 6, i.e., no longer rests on cable 6. This is shown in FIG. 4B. In this snapshot, only other feeler lever 11b is still resting on cable 6.

As paving machine 1 continues to move on, feeler lever 11a can be drawn past support 5 and, as shown in FIG. 4C, pivot automatically about its axis of rotation 13a back to its initial position, i.e., to first orientation 14a, in which it rests on cable 6 again. Next, according to FIG. 4C, other feeler lever 11b strikes against support 5 that has already been passed by feeler lever 11a and is pushed out of its first orientation 14b, is spaced from cable 6, and maneuvered past support 5, just like it happened previously with other feeler lever 11a.

The FIGS. 4A-4C show that the two feeler levers 11a, 11b are configured such that one of two feeler levers 11a, 11b is in first orientation 14a, 14b, in which it is positioned resting on cable 6, at least always when the other of two feeler levers 11a, 11b is pressed, by way of support 5 that is used to tension cable 6, to a second orientation 15a, 15b in which it is spaced from cable 6.

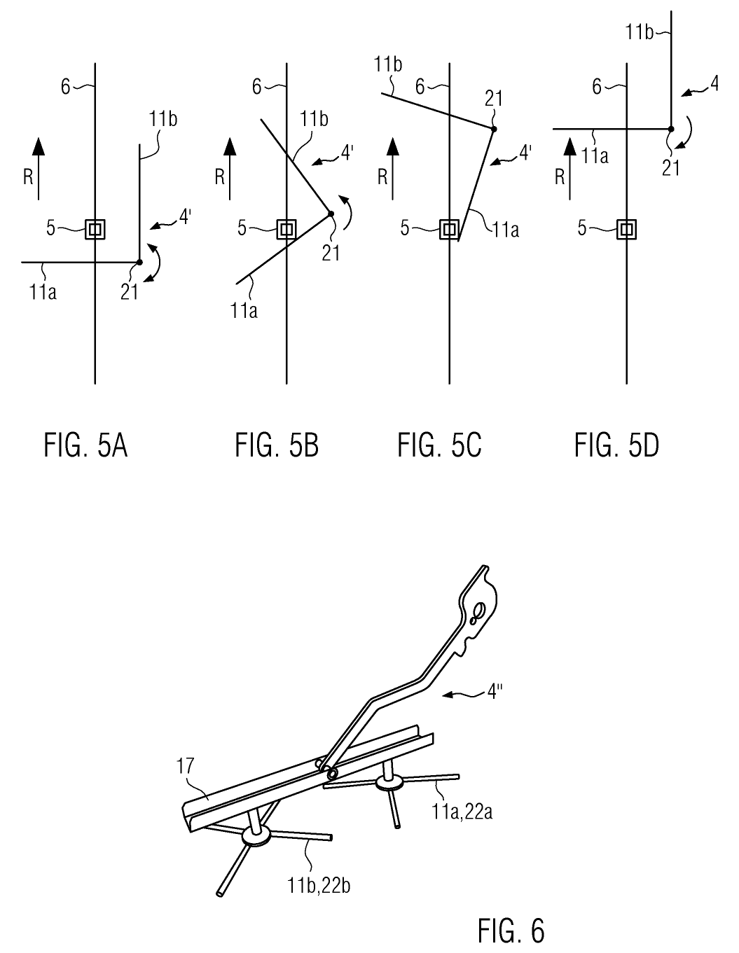

This principle of continuous cable feeling according to feeler levers 11a, 11b shown in FIGS. 4A-4C can also be achieved using the embodiment shown in FIGS. 5A-5D.

FIGS. 5A-5D show a measuring device 4' in a schematic plan view on which feeler levers 11a, 11b are present in the form of a double lever mounted to be rotatable about a single axis of rotation 21.

In principle, measuring device 4' is mounted above cable 6 to be pre-tensioned according to the orientation shown in FIG. 5A. Feeler lever 11a rests on cable 6, i.e., is disposed in first orientation 14a. Other feeler lever 11b is disposed in second orientation 15b, since it does not rest on cable 6, but is spaced therefrom.

In FIG. 5B, feeler lever 11a strikes against support 5 and is pushed away by the latter causing feeler levers 11a, 11b to rotate together about axis of rotation 21. This causes feeler lever 11b to pivot onto cable 6. According to the snapshot during the paving run shown in FIG. 5B, two feeler levers 11a, 11b are each positioned resting on cable 6.

FIG. 5C shows that, as paving machine 1 continues to travel onward, feeler levers 11a, 11b continue to rotate about axis of rotation 21 such that, at the point in time shown in FIG. 5C, feeler lever 11a is spaced from cable 6, whereas feeler lever 11b rests on cable 6.

Continued travel of paving machine 1 causes feeler levers 11a, 11b to pivot together according to FIG. 5D about axis of rotation 21 to their initial position shown in FIG. 5A so that feeler lever 11a rests on cable 6 again.

Measuring device 4' shown in FIGS. 5A-5D enables one of two feeler levers 11a, 11b, and at times even both feeler levers 11a, 11b, to always rest on cable 6 in order to enable continuous feeling of the cable even when the pass supports 5 along the paving section.

FIG. 6 shows a measuring device 4" in which feeler levers 11a, 11b are present in the form of multiple levers rotatable about axes of rotation 13a, 13b that are spaced from one another. According to FIG. 6, the multiple levers are configured as rotation stars 22a, 22b. Like feeler levers 11a, 11b shown in FIGS. 4A-4C, rotation stars 22a, 22b shown in FIG. 6 can be configured on measuring device 4'' such that one of two rotation stars 22a, 22b is positioned in a first orientation 14a, 14b, in which it rests on cable 6, at least always when other rotation star 22a, 22b is pressed, by way of a support 5 used to tension cable 6, to a second orientation 15a, 15b in which it is spaced from cable 6, i.e., no longer rests on it.

What is claimed is:

1. A measuring device for a paving machine, comprising a height sensor as well as a pivot module which is mounted on the height sensor to be pivotable about a pivot axis and which comprises a feeling device comprising two feeler levers for feeling a cable tensioned as a height reference along a paving section of the paving machine, wherein the two feeler levers are configured such that one of the two feeler levers is in a first orientation, in which it is positioned resting on the cable, at least always when the other of the two feeler levers is pressed, by way of a support that is used to tension the cable, into a second orientation, in which it is spaced from the cable.

2. The measuring device according to claim 1, wherein the feeler levers are present as separate feeler levers that are mounted to be rotatable about axes of rotation that are spaced from one another.

3. The measuring device according to claim 2, wherein at least one of the feeler levers is a single lever or a multiple lever.

4. The measuring device according to claim 2, wherein the feeler levers are pretensioned to the first orientation under spring load.

5. The measuring device according to claim 1, wherein the feeler levers are formed as a double lever that is mounted to be rotatable about a single axis of rotation.

6. The measuring device according to claim 5, wherein, when feeling the cable, the one feeler lever is positioned in the first orientation and the other feeler lever is positioned in the second orientation pretensioned under spring load.

7. The measuring device according to claim 5, wherein the feeler levers are aligned at an angle greater than 80° and less than 100° to each other.

8. The measuring device according to claim 5, wherein the feeler levers are oriented at a right angle to each other.

9. The measuring device according to claim 1, wherein the feeling device comprises an additional feeler lever spaced from the one feeler lever, and the additional feeler lever and the one feeler lever are configured to be in the first orientation when feeling the cable while the other feeler lever is in the second orientation.

10. The measuring device according to claim 1, wherein the pivot module forms a parallelogram hinge for supporting the feeling device.

11. The measuring device according to claim 10, wherein the parallelogram hinge comprises a mounting rail for the feeler levers.

12. The measuring device according to claim 10, wherein the parallelogram hinge comprises a counterweight unit for the feeling device.

13. The measuring device according to claim 1, wherein each of the feeler levers comprises an upwardly rising bevel at an outer end of the feeler lever.

14. The measuring device according to claim 1, wherein the feeling device comprises at least one stopper element for holding the feeler levers in a predetermined orientation relative to the cable and/or the feeler levers can be used for cable feeling at each of two sides of the paving machine.

15. A paving machine comprising the measuring device according to claim 1.

16. A method for continuously feeling a cable stretched along a paving section of a paving machine as a height reference using a measuring device on which a feeling device with at least two feeler levers for feeling the cable is employed, wherein one of the at least two feeler levers is in a first orientation in which it rests on the cable whereas another of the at least two feeler levers is pushed away from the cable by a support that tensions the cable to a second orientation in which it is spaced from the cable.
